(19) United States
(12) Patent Application Publication
(10) Pub. No.: US 2025/0146578 A1
(43) Pub. Date: May 8, 2025

(54) RETROFIT DRAIN VALVE

(71) Applicant: SAUDI ARABIAN OIL COMPANY, Dharan (SA)

(72) Inventors: Waleed A. Alusaimi, Khobar (SA); Mohammed N. Al Shammari, Dhahran (SA)

(73) Assignee: SAUDI ARABIAN OIL COMPANY, Dhahran (SA)

(21) Appl. No.: 18/504,891

(22) Filed: Nov. 8, 2023

(51) Int. Cl. F16K 1/02

(52) U.S. Cl. CPC F16K 1/02

(57) ABSTRACT

A drain valve system is configured to be connected to a body. The drain valve system includes a casing configured to be sealed against an outside wall of the body, a conduit fluidly connected to the casing, a drain valve fluidly connected to the conduit, and an opener mechanism extending through the casing. The opener mechanism is configured to engage with the casing so as to cause a pressure tight seal between the casing and the opener mechanism. The opener mechanism is configured to open a hole in the body. The conduit is fluidly connected to the inside of the body through the hole opened by the opener mechanism.

### BACKGROUND

To properly maintain valves, it is often necessary to shut down the system the valve is attached to, in order to drain and flush the valve itself. Some valves come with an additional drain valve installed to allow flushing of the valve without shutting down the system the valve is attached to. For valves lacking a drain valve, it is beneficial to be able to attach a drain valve and flush the first valve without ever having to shut down the system they are attached to.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a drain valve system configured to be connected to a body. The drain valve system includes a casing configured to be sealed against an outside wall of the body, a conduit fluidly connected to the casing, a drain valve fluidly connected to the conduit, and an opener mechanism extending through the casing. The opener mechanism is configured to engage with the casing so as to cause a pressure tight seal between the casing and the opener mechanism. The opener mechanism is configured to open a hole in the body. The conduit is fluidly connected to the inside of the body through the hole opened by the opener mechanism.

In general, in one aspect, embodiments disclosed herein relate to a method for installing a drain valve onto a body. The method includes attaching a casing to the body. The casing is part of a draining apparatus. The method further includes using an opener mechanism that extends through the casing of the draining apparatus to open a hole in the body. The draining apparatus includes the drain valve that is fluidly connected to the inside of the body by the hole opened by the opener mechanism.

Other aspects and advantages of the claimed subject matter will be apparent from the following description and the appended claims.

### BRIEF DESCRIPTION OF DRAWINGS

FIG. 1 shows a drain valve system in accordance with one or more embodiments.

FIG. 2 shows a cutaway drain valve system in accordance with one or more embodiments.

FIG. 3 shows a piercer opener in accordance with one or more embodiments.

FIG. 4 is a flowchart in accordance with one or more embodiments.

### DETAILED DESCRIPTION

In one aspect, embodiments disclosed herein relate to a system and method for installing a drain valve to a body. The body may be a valve, pipe, tank, or other body in which exists a fluid. The fluid may further be pressurized, heated, corrosive, or otherwise requiring containment and control when draining.

Draining and flushing are important parts of maintenance for any fluid handling body. For example, to remove waste buildup, inject cleaning chemicals, or empty the body of fluid.

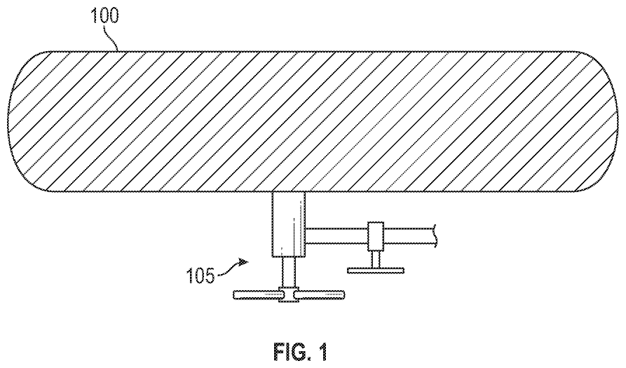

FIG. 1 shows a drain valve system in accordance with one or more embodiments. Drains are common features on all manner of bodies 100, such as the tank shown in this embodiment. The drain valve system 105 shown is designed to be attachable to a wide range of bodies 100, such as tanks, pipes, and valves.

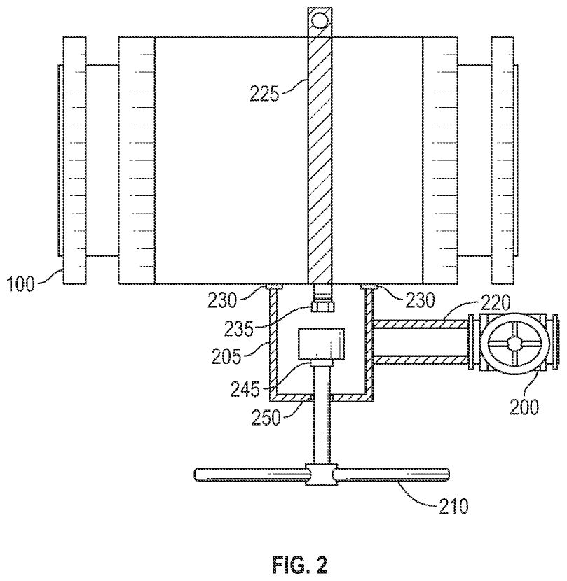

FIG. 2 shows a cutaway drain valve system in accordance with one or more embodiments. The drain valve system 105 comprises a drain valve 200, conduit 220, casing 205, and an opener mechanism 210 configured such that the drain valve 105, conduit 220, and casing 205 are in fluid communication with each other. The opener mechanism 210 may open a hole in a wall of the body 100 to fluidly connect the inside of the body 100 to the casing 205. The casing 205 can be firmly attached to an outside wall of the body 100 by way of a clamp 225 and may be sealed pressure tight with help of a first gasket 230 positioned between the casing 205 and the body 100.

To open a hole in the body, many varieties of opener could be used. For instance, if there is a threaded plug 235 that can be removed from the body 100 to open a hole in the body 100, the opener mechanism 210 may include a socket 245. The opener mechanism 210 may extend through the casing so that one end may come in contact with the plug 235 or outside wall of the body 100 and the other is accessible for manipulation by an operator and/or a machine. To contain the released fluid once an opening is made in the body 100, the casing may have a second gasket 250 between the opener mechanism 210 and the casing 205. Alternately, the opener mechanism 210 may engage with the casing 205 to cause a pressure tight seal without requiring second gasket 250.

In one or more embodiments, the socket 245 of the opener mechanism 210 may be configured to retain the threaded plug 235 to allow the threaded plug 235 to be selectively reinstalled, thus closing the hole in the body 100.

In one or more embodiments, the drain valve apparatus may be attached by a form of bonding rather than using a clamp and gasket. For example, the casing 205 may be bonded to the body 100 by welding, brazing, gluing, or epoxying.

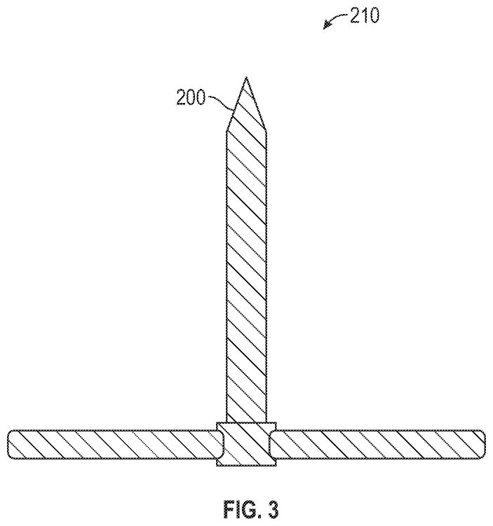

FIG. 3 shows a piercer opener in accordance with one or more embodiments. In one embodiment, a plug may not be present in the body 100. To make a hole in the body 100, an opener mechanism 210 comprising a piercer 300 may be used to pierce a hole in the wall of the body 100 itself. The piercer 300 could be a spike configured to be driven directly through the wall of the body 100 or could be a different type of piercer, such as a drill or hole saw. Piercers 300 are best suited to low pressure operations where the walls of the body 100 are relatively thin and their structural integrity is not as critical as when the fluid is pressurized.

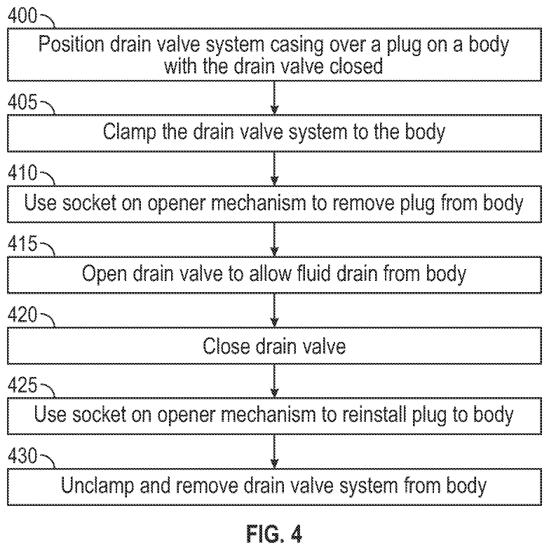

FIG. 4 shows a flowchart in accordance with one or more embodiments. The flowchart shown describes a method for using one embodiment of the present invention to drain a body 100. First, in Step 400, the casing 205 of the drain valve system 105 is positioned over a plug on a body with the drain valve of the drain valve system closed. Next, in Step 405, the drain valve system 105 is clamped to the body 100. In Step 410, a socket 245 is used on an opener mechanism 210 to remove a plug 235 from the body 100 to open a hole in the body 100. When the drain valve 200 is opened, in Step 415, the fluid in the body 100 drains through the drain valve system 105. Then, in Step 420, the drain valve 200 is closed once the fluid has been satisfactorily drained. In Step 425, the socket 245 is again used on the opener mechanism 210 to reinstall the plug 235 to the body. Lastly, in Step 430, the drain valve system 105 from the body 100 may be unclamped and removed. In other embodiments, the drain valve system 105 may be permanently installed to the body by bonding, welding, or the like, and the plug 235 may not be uninstalled/reinstalled.

Embodiments of the present disclosure may provide at least one of the following advantages. The addition of a drain valve to a body allows easy draining and flushing of the body without shutting down the system that the body is attached to and while not risking spilling fluid. The addition of a valve to a body further allows the easy expansion or reduction of the broader system without a shut down. The drain valve apparatus can be easily customized to suit the exact needs of the application in terms of pressure strength, corrosive/heat resistance, and size among other factors.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A drain valve system configured to be connected to a body, the drain valve system comprising:
a casing configured to be sealed against an outside wall of the body,
a conduit fluidly connected to the casing,
a drain valve fluidly connected to the conduit, and
an opener mechanism extending through the casing and configured to engage with the casing so as to cause a pressure tight seal between the casing and the opener mechanism,
wherein the opener mechanism is configured to open a hole in the body, and
wherein the conduit is fluidly connected to an inside of the body through the hole.

2. The drain valve system of claim 1,
wherein the opener mechanism comprises a socket for removing a threaded plug comprised in the body to open the hole in the body.

3. The drain valve system of claim 2,
wherein the opener mechanism is configured to reinstall the threaded plug to the body to close the hole in the body.

4. The drain valve system of claim 1,
wherein the opener mechanism comprises a piercer for piercing the body to open the hole in the body.

5. The drain valve system of claim 1,
wherein the casing connects to the body by clamps comprised in the drain valve system.

6. The drain valve system of claim 1,
wherein the casing connects to the body by bonding.

7. The drain valve system of claim 1,
wherein the casing comprises a first gasket to provide a pressure tight seal between the casing and the outside wall of the body.

8. The drain valve system of claim 1,
wherein the casing comprises a second gasket to provide a pressure tight seal between the opener mechanism and the casing.

9. The drain valve system of claim 1,
wherein the inside of the body is pressurized.

10. The drain valve system of claim 1,
wherein the casing connects to the body by welding.

11. A method for installing a drain valve onto a body, the method comprising:
attaching a casing comprised in a draining apparatus to the body, and
using an opener mechanism extending through the casing of the draining apparatus to open a hole in the body,
wherein the draining apparatus comprises the drain valve that is fluidly connected to the body by the hole opened by the opener mechanism.

12. The method of claim 11,
wherein using the opener mechanism to open a hole in the body comprises using a socket comprised in the opener mechanism to remove a threaded plug comprised in the body.

13. The method of claim 12,
further comprising using the socket to reinstall the threaded plug to the body.

14. The method of claim 13,
further comprising removing the drain apparatus from the body after the threaded plug has been reinstalled.

15. The method of claim 11,
wherein using the opener mechanism to open a hole in the body comprises using a piercer comprised in the opener mechanism to pierce a hole in a wall of the body.

16. The method of claim 11,
wherein attaching the casing to the body comprises bonding the casing to the body.

17. The method of claim 11,
wherein attaching the casing to the body comprises clamping the apparatus to the body with clamps comprised in the apparatus.

18. The method of claim 11,
wherein attaching the casing to the body comprises welding the casing to the body.
